(19) United States
(12) Patent Application Publication
(10) Pub. No.: US 2020/0074777 A1
(43) Pub. Date: Mar. 5, 2020

(54) LOCATION-BASED DYNAMIC POLLING

(71) Applicant: INTERNATIONAL BUSINESS MACHINES CORPORATION, Armonk, NY (US)

(72) Inventors: LISA SEACAT DELUCA, Baltimore, MD (US); KELLEY ANDERS, EAST NEW MARKET, MD (US); JEREMY R. FOX, GEORGETOWN, TX (US)

(21) Appl. No.: 16/118,877

(22) Filed: Aug. 31, 2018

(51) Int. Cl. G07C 13/00; H04L 29/08

(52) U.S. Cl. CPC G07C 13/00; G06Q 2230/00; H04L 67/18

(57) ABSTRACT

Embodiments of the present invention disclose a method, computer program product, and system for a location-based dynamic polling application. The computer may receive a poll with at least one poll question and at least one potential answer for each at least one poll question from a creator. A specified polling location and additional polling criteria may be received from the creator, wherein the specified polling location is used to target a specific set of users. The specific set of users may be identified within the specified polling location that match the additional polling criteria by tracking a plurality of user computing devices. The poll may be sent to the specific set of users. A result of the poll may be generated by adding up each vote from each of the users of the specific set of users.

### BACKGROUND

The present invention relates generally to the field of computing, and more particularly to dynamic polling.

Oftentimes, there arises a situation where you′d like to ask the people in a room or people traveling together for a consensus on a question without having to interrupt everyone and ask the question. Dynamic polling allows a question to be asked and the result to change as more and more people answer the question. Dynamic polling makes it so the people who receive the poll are the people who the creator of the poll indented to reach.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for a location-based dynamic polling application. The computer may receive a poll with at least one poll question and at least one potential answer for each at least one poll question from a creator. A specified polling location and additional polling criteria may be received from the creator, wherein the specified polling location is used to target a specific set of users. The specific set of users may be identified within the specified polling location that match the additional polling criteria by tracking a plurality of user computing devices. The poll may be sent to the specific set of users. A result of the poll may be generated by adding up each vote from each of the users of the specific set of users.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a functional block diagram illustrating a system for a location-based dynamic polling application, in accordance with an embodiment of the present invention.

FIG. 2 is a flowchart depicting operational steps of the system for the location-based dynamic polling application of FIG. 1, in accordance with an embodiment of the present invention.

FIG. 3 is an example of a location-based dynamic poll, where the present invention can be implemented.

FIG. 4 is a block diagram of components of a computing device of the system for the location-based dynamic polling application of FIG. 1, in accordance with embodiments of the present invention.

FIG. 5 depicts a cloud computing environment according to an embodiment of the present invention.

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to dynamic polling. The following described exemplary embodiments provide a system, method, and program for, among other things, a location-based dynamic polling application that can dynamically invite users within a preferred distance and other criteria to participate in a poll. Therefore, the present invention has the capacity to improve the technical field of computer functionality by more efficiently gathering data.

As previously described, oftentimes there arises a situation where you′d like to ask the people in a room or people traveling together for a consensus on a question without having to interrupt everyone and ask the question. Dynamic polling allows a question to be asked and the result to change as more and more people answer the question. Dynamic polling makes it so the people who receive the poll are the people who the creator of the poll indented to reach.

There are systems that exchange global positioning system (GPS) data or other positioning data for the purpose of group activities. However, the users of these systems must opt-in and are part of a defined closed group. There are other systems that have dynamic voting but the geographical range of users reached cannot be set to a specific location. Other systems have difficulty determining geographically vertical delineation. Furthermore, other systems have complex voting methods that store user personal information. As such, it may be advantageous to, among other things, implement a system for a location-based dynamic polling application that is simple and allows the creator to select the specific location for the poll in order to more efficiently gather needed data.

According to one embodiment, the location-based dynamic polling application may allow the user to select a location and other criteria for the users who will receive the poll. A creator may enter poll questions and potential answers using existing poll creation and form creation techniques. The creator may then specify where they wish to send the poll and who they want to send the poll to. The creator could specify the location of the users relative to the creator's location, a geographic point, another user's location, within a geofence, a traveling geofence, or other such relative locations. The creator may set optional poll features such as demographics of users, social friendship, organization of users, participates at an event, or other such features. The creator may choose when to send the poll. The location-based dynamic polling application may find users nearby the creator's specified location. This could be done using Bluetooth proximity, GPS, manual location check-in of the users, cellular triangulation, or other such methods. The location-based dynamic polling application may determine whether the users found match the location and other criteria set by the creator. When the user does not match the location and criteria, a poll may not be sent. When the user does match the location and criteria, a poll may be sent to the user. The creator may view the results as the users are responding.

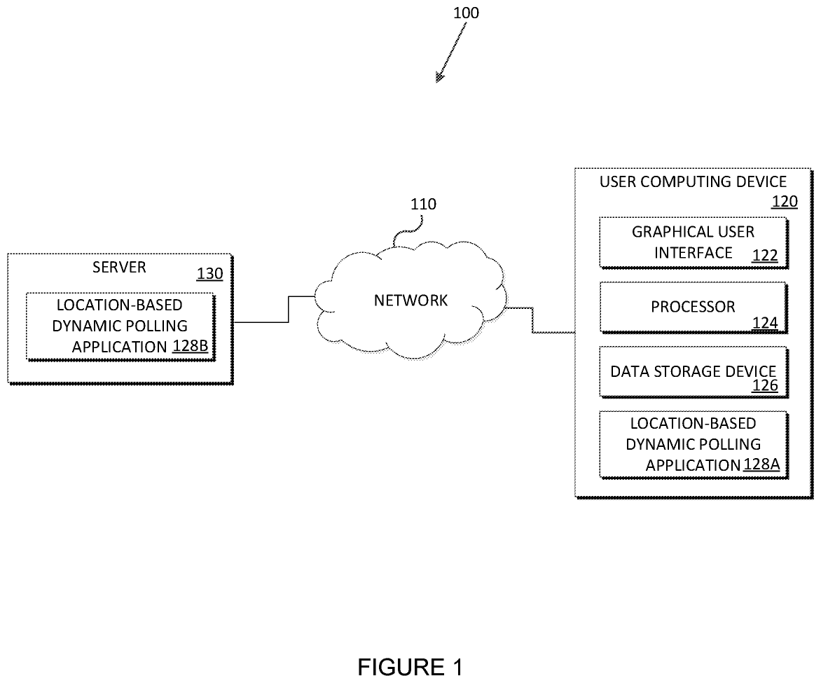

Referring to FIG. 1, a functional block diagram illustrating a system for a location-based dynamic polling application 100 is depicted, according to at least one embodiment. The location-based dynamic polling application 100 may include a user computing device 120 and a server 130 interconnected via a network 110.

The network 110 may include various types of communication networks, such as a wide area network (WAN), a local area network (LAN), a telecommunication network, a wireless network, a public switched network and/or a satellite network. The network 110 may include connections, such as wire, wireless communication links, or fiber optic cables. It may be appreciated that FIG. 1 provides only an illustration of one implementation and does not imply any limitations with regard to the environment in which different embodiments may be implemented. Many modifications to the depicted environments may be based on design and implementation requirements.

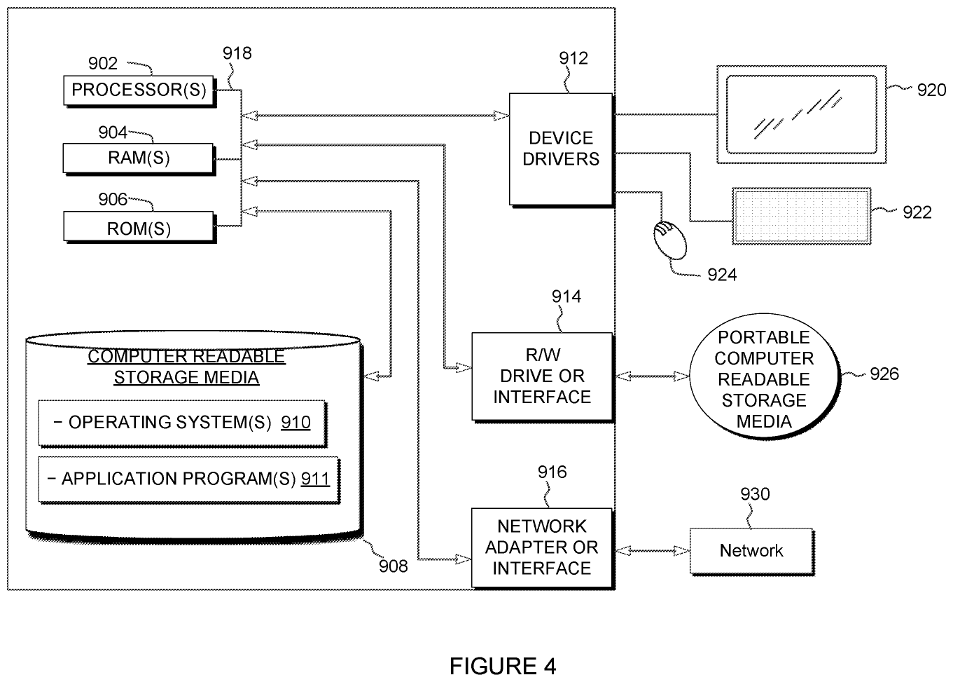

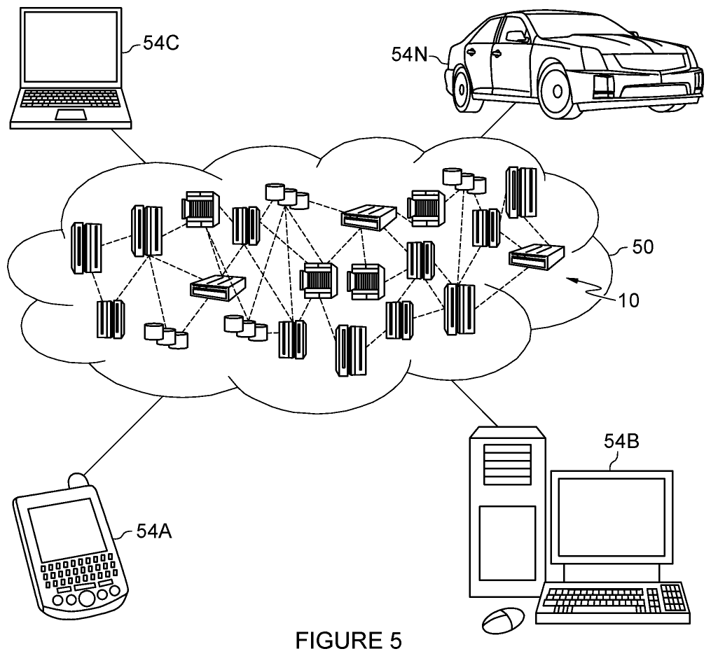

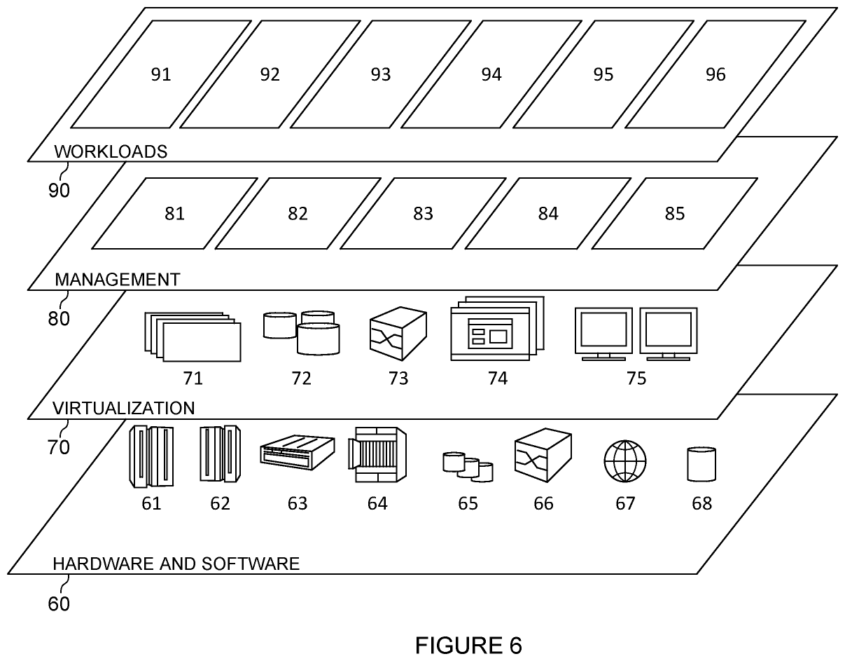

The user computing device 120 may include a graphical user interface 122, a processor 124 and a data storage device 126 that is enabled to host and run a software program, and a location-based dynamic polling application 128A, and communicate with the server 130 via the network 110, in accordance with one embodiment of the invention. The user computing device 120 may be, for example, a mobile device, a smart phone, a personal digital assistant, a netbook, a laptop computer, a tablet computer, a desktop computer, or any type of computing device capable of running a program or accessing a network. The user computing device 120 may be able to track movements using GPS, WIFI tracking, Bluetooth, cellular triangulation, and other such methods to track the user computing device 120. The user computing device 120 may include internal and external hardware components, as described in further detail below with respect to FIG. 4. In other embodiments, the server 130 may operate in a cloud computing environment, as described in further detail below with respect to FIG. 5 and FIG. 6.

The user computing device 120 represents a computing device that may include a user interface, for example, a graphical user interface 122. The graphical user interface 122 can be any type of application that contains an interface capable of receiving the creator's inputs, receiving user votes, and displaying poll results, for example, the application can be a web application, a graphical application, or any other type of application/program that allows the creator to make inputs and view poll results and allows the users to vote.

The server 130 may be a laptop computer, a netbook computer, a personal computer (PC), a desktop computer, or any programable electronic device or any network of programable electronic devices capable of hosting and running a location-based dynamic polling application 128B and communicating with the user computing device 120 via the network 110, in accordance with embodiments of the invention. The server 130 may include internal and external hardware components, as depicted and described in further detail below with reference to FIG. 4. In other embodiments, the server 130 may operate in a cloud computing environment, as depicted in FIG. 6 and FIG. 7.

The location-based dynamic polling application 128A, 128B may receive poll questions and potential answers from a creator. The creator may use existing poll creation and form creation techniques, such as, the poll questions being in the form of a multiple-choice question. The location-based dynamic polling application 128A, 128B may receive a specified location of the poll from the creator. The creator could specify the location of the users relative to the creator's location, a geographic point, another user's location, within a geofence, a traveling geofence, or other such relative locations. The location-based dynamic polling application 128A, 128B may receive additional poll criteria from the creator. The creator may set optional poll features, such as demographics of users, social friendship, organization of users, participants at an event, or other such features. The location-based dynamic polling application 128A, 128B may receive an indication that the creator is ready to send the poll, such the user selecting or interacting with a GUI button to send the poll or a user swiping a finger on a touchscreen in a preconfigured direction. The location-based dynamic polling application 128A, 128B may then find users within the location specified by the creator. The users may be found using Bluetooth proximity, GPS, manual location check-in of the users, cellular triangulation, or other such methods. Furthermore, the location-based dynamic polling application 128A, 128B may determine whether the users found match the location and other additional criteria. When it has been determined that a user found matches the location and other additional criteria, the location-based dynamic polling application 128A, 128B may send the poll to the user. Additionally, the location-based dynamic polling application 128A, 128B may display the results of the poll to the creator, a group of people that were polled, a subgroup of the people that were polled, or a group of people that were not polled. The location-based dynamic polling application 128A, 128B may exist, either wholly or in part, on either the user computing device 120 or the server 130 or on both the user computing device 120 and the server 130.

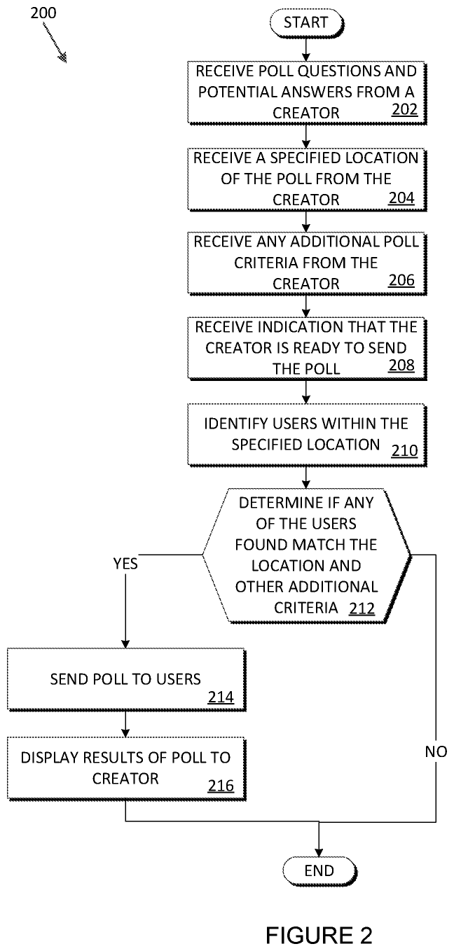

FIG. 2 is an operational flowchart 200 illustrating the system for the use of the location-based dynamic polling application 128A, 128B. At 202, the location-based dynamic polling application 128A, 128B receives poll questions and potential answers from a creator. The creator, who may be a user, may input the poll questions and potential answers to the location-based dynamic polling application 128A, 128B on the user computing device 120 via the graphical user interface 122. The creator may use existing poll creation and form creation techniques, such as the poll question and answers being in the form of a multiple-choice questions. For example, a boss may want to ask his employees how late they can work that day. The boss could create a poll question of “How late can you work today?” with answer choices of “5:00 p.m.”, “6:00 p.m.”, and “7:00 p.m.”.

Then, at 204, the location-based dynamic polling application 128A, 128B receives a specified location of the poll from the creator. The creator may input a specified location to the location-based dynamic polling application 128A, 128B on the user computing device 120 via the graphical user interface 122. The creator may indicate the intended poll location by specifying the location of the users relative to the creator's location, a geographic point, another user's location, within a geofence, a traveling geofence, or other such relative locations. For example, the boss could indicate that he wants the poll to be sent to all people on the third floor of the building that he is in.

Next, at 206, the location-based dynamic polling application 128A, 128B receives any additional poll criteria from the creator. The creator may input any additional criteria to the location-based dynamic polling application 128A, 128B on the user computing device 120 via the graphical user interface 122. The creator may set optional poll features in order to further target the polling recipients. The additional poll features may be features such as demographics of users, social friendship, organization of users, participates at an event, or other such features. For example, the boss may specify that he wants the poll only to be sent to those employees in the engineering department.

Then, at 208, the location-based dynamic polling application 128A, 128B receives an indication that the creator is ready to send the poll. The creator may indicate on the user computing device 120 via the graphical user interface 122 when they are ready to send the poll. The user computing device 120 may transmit the user's indication to the location-based dynamic polling application 128A, 128B. For example, the boss may select a “send poll” option after poll specifications are satisfactory.

Next, at 210, the location-based dynamic polling application 128A, 128B identifies users within the specified location. The users may be identified using Bluetooth proximity, GPS, manual location check-in of the users, cellular triangulation, or other such methods. The location-based dynamic polling application 128A, 128B may search for user computing devices 120 in proximity to the creator specified location of the poll. For example, the location-based dynamic polling application 128A, 128B may locate the user computing devices 120 of all of the employees on the third floor of the building.

Then, at 212, the location-based dynamic polling application 128A, 128B determines whether any of the users found match the location and the other additional criteria. When the location-based dynamic polling application 128A, 128B determines that at least one user found matches the location and other additional criteria (step 212, “Yes” branch), the location-based dynamic polling application 128A, 128B may send the poll to those users. When the location-based dynamic polling application 128A, 128B determines that there are no users who match the location and other additional criteria (step 212, “No” branch), the user of the location-based dynamic polling application 300 may terminate after a preconfigured period of time of searching. In at least one embodiment, the other additional criteria may be demographic information determined by analyzed a participant's social media network or reviewing participant-entered information, such as home address, occupation, and age.

Next, at 214, when the location-based dynamic polling application 128A, 128B determines that at least one user found matches the location and other additional criteria (step 212, “Yes” branch), the location-based dynamic polling application 128A, 128B sends the poll to those users. The location-based dynamic polling application 128A, 128B transmits the poll questions and answer choices to the user computing device 120 via the graphical user interface 122 of each of the users determined to match the polling criteria. The users can then answer the poll. The users response may be collected by the location-based dynamic polling application 128A, 128B. For example, an engineer on the third floor of the building can respond that he is available to work until “6:00 p.m.”.

Then, at 216, the location-based dynamic polling application 128A, 128B displays the results of the poll to the creator. The location-based dynamic polling application 128A, 128B may collect the users' answers and tally them up in order to determine the result of the poll. The location-based dynamic polling application 128A, 128B may transmit the result of the poll to the creator on the user computing device 120 via the graphical user interface 122. For example, the location-based dynamic polling application 128A, 128B may transmit to the boss' user computing device 120 that the majority of users selected “6:00 p.m.” as the time that they could work until.

It may be appreciated that FIG. 2 provides only an illustration of one implementation and does not imply any limitations with regard to how different embodiments may be implemented. Many modifications to the depicted environments may be made based on design and implementation requirements. For example, in at least one embodiment, the location-based dynamic polling application 128A, 128B may transmit additional information such as GPS coordinates, directions, or other such information to all of the user computing devices 120 that participated in the polls.

In an additional embodiment, once results from the poll have been received, the location-based dynamic polling application 128A, 128B may perform an action consistent with the goal of the poll. For example, if the poll requests a group of users to vote upon a restaurant at which to dine, the location-based dynamic polling application 128A, 128B may, once the poll has determined a particular restaurant that the group of users prefers, transmit GPS coordinates to a GPS device and set the GPS coordinates as a new via point. The location-based dynamic polling application 128A, 128B may also transmit additional relevant information to a third-party based on the result of the poll. For example, if the poll was about where to eat dinner, the restaurant that won the poll may be contacted to make a reservation for the estimated time of arrival of the group of users.

In a further embodiment, the location-based dynamic polling application 128A, 128B may transmit a subsequent poll to the users with additional questions. The creator may determine based on the initial poll results that a subsequent poll be sent. The creator may input additional poll questions and potential answers for the subsequence poll. The location-based dynamic polling application 128A, 128B may transmit the subsequent poll to the same set of users who received the initial poll. The location-based dynamic polling application 128A, 128B may display the results of the subsequent poll to the creator. For example, if the initial poll was about where to eat dinner, the subsequent poll could be “what would you like to order?”. The location-based dynamic polling application 128A, 128B may then gather the user meal orders and transmit each user order to the restaurant for fulfillment.

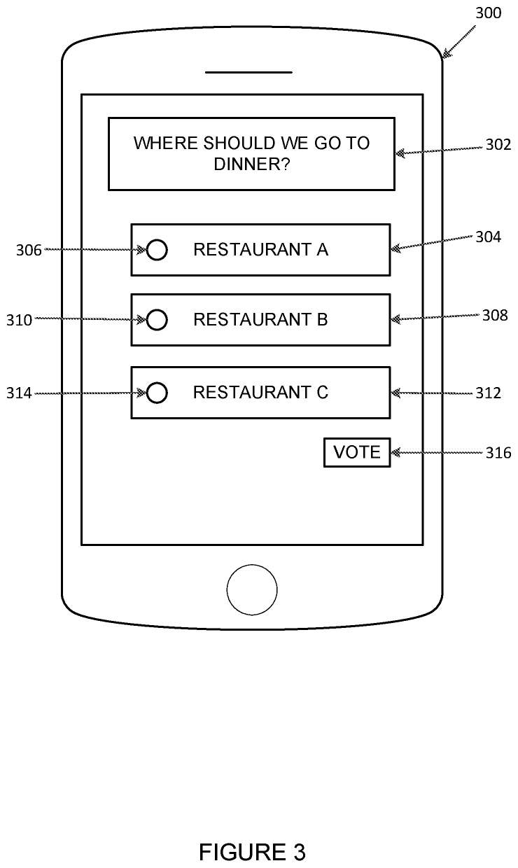

FIG. 3 illustrates an example of a location-based dynamic poll. The user computing device 300 may include a poll question 302, such as “Where should we go to dinner?”, a first option 304, such as “Restaurant A”, a selection button 306 that goes with the first option 304, a second option 308, such as “Restaurant B”, a selection button 310 that goes with the second option 308, a third option 312, such as “Restaurant C”, a selection button 314 that goes with the third option 312, and a “vote” button 316. For example, a basketball team may be driving back to school on a bus after a game. Instead of the coach asking everyone out loud where they want eat dinner, the coach creates a location-based dynamic poll using the location-based dynamic polling application 128A, 128B. The coach may input the poll question 302, “Where should we go to dinner?”, and the potential answers, such as the first option 304, “Restaurant A”, the second option 308, “Restaurant B”, and the third option 312, “Restaurant C”, into the location-based dynamic polling application 128A, 128B. The coach may then input on the location-based dynamic polling application 128A, 128B that the poll should be sent to everyone within thirty feet of herself. The coach may send the poll. The location-based dynamic polling application 128A, 128B may find all of the users within thirty feet of the coach. Furthermore, the location-based dynamic polling application 128A, 128B may send the poll to all of the users found within thirty feet of the coach. Each of the players that receives the poll may press one of the select button 306 that goes with the first option 304, the select button 310 that goes with the second option 308, or the select button 314 that goes with the third option 312. After the player has made their selection, they may press the “vote” button 316. The location-based dynamic polling application 128A, 128B may transmit the results of the poll to the coach's user computing device 120 via the graphical user interface 122. The coach may create a subsequent poll with a poll question 302, such as “What would you like to order?”, and a first option 304, such as “Pizza”, a second option 308, such as “Pasta”, and a third option 312, such as “Chicken Tenders”. The location-based dynamic polling application 128A, 128B may transmit the subsequent poll to the same set of users as the initial poll. The results of the poll may be displayed on the coach's user computing device 120. Furthermore, the restaurant that won the initial poll may be contacted to order the food which won the subsequence poll.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

FIG. 4 depicts a block diagram of components of the user computing device 120 of the location-based dynamic polling application 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

The user computing device 120 and/or the server 130 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, the location-based dynamic polling application 128A, 128B (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The user computing device 120 and/or the server 130 may also include a R/W drive or interface 914 to read from and write to one or more portable computer readable storage media 926. Application programs 911 on the user computing device 120 and/or the server 130 may be stored on one or more of the portable computer readable storage media 926, read via the respective R/W drive or interface 914 and loaded into the respective computer readable storage media 908.

The user computing device 120 and/or the server 130 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the user computing device 120 and/or the server 130 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The user computing device 120 and/or the server 130 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and location-based dynamic polling 96. Location-based dynamic polling 96 relates to receiving polling questions, potential answers, polling location, and other additional criteria from a creator. Location-based dynamic polling 96 may transmit to users who match the location and additional criteria and the results are returned to the poll creator.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method for a location-based dynamic polling application, the method comprising:
receiving, by a computer, a poll with at least one poll question and at least one potential answer for each at least one poll question from a creator;
receiving a specified polling location and additional polling criteria from the creator, wherein the specified polling location is used to target a specific set of users;
identifying the specific set of users within the specified polling location that match the additional polling criteria by tracking a plurality of user computing devices;
sending the poll to the specific set of users; and
generating a result of the poll by adding up each vote from each of the users of the specific set of users.

2. The method of claim 1, further comprising:
performing an action based on the generated result, wherein the action is selected from a group consisting of adding a via point to a travel route, transmitting user-provided information to a third party, displaying the results of the poll to the group, and generating a subsequent poll to transmit to the specific set of users.

3. The method of claim 1, further comprising:
receiving an indication from the creator that the poll is ready to be sent, wherein the indication is selected from a group consisting of a user interaction with a button and a user finger swipe in a preconfigured direction.

4. The method of claim 1, further comprising:
receiving a vote for a poll answer from each of the users who participate in the poll.

5. The method of claim 1, further comprising:
displaying the result of the poll.

6. The method of claim 1, further comprising:
receiving a subsequent poll with at least one poll question and at least one potential answer for each at least one poll question from the creator.

7. The method of claim 6, further comprising:
sending the subsequent poll to the identified specific set of users that includes at least one follow up question based on the result of the poll.

8. A computer program product for the location-based dynamic polling application, the computer program product comprising:
one or more non-transitory computer-readable storage media and program instructions stored on the one or more non-transitory computer-readable storage media capable of performing a method, the method comprising:
receiving, by a computer, a poll with at least one poll question and at least one potential answer for each at least one poll question from a creator;
receiving a specified polling location and additional polling criteria from the creator, wherein the specified polling location is used to target a specific set of users;
identifying the specific set of users within the specified polling location that match the additional polling criteria by tracking a plurality of user computing devices;
sending the poll to the specific set of users; and
generating a result of the poll by adding up each vote from each of the users of the specific set of users.

9. The computer program product of claim 8, further comprising:
performing an action based on the generated result, wherein the action is selected from a group consisting of adding a via point to a travel route, transmitting user-provided information to a third party, displaying the results of the poll to the group, and generating a subsequent poll to transmit to the specific set of users.

10. The method of claim 8, further comprising:
receiving an indication from the creator that the poll is ready to be sent, wherein the indication is selected from a group consisting of a user interaction with a button and a user finger swipe in a preconfigured direction.

11. The computer program product of claim 8, further comprising:
receiving a vote for a poll answer from each of the users who participate in the poll.

12. The computer program product of claim 8, further comprising:
displaying the result of the poll.

13. The computer program product of claim 8, further comprising:
receiving a subsequent poll with at least one poll question and at least one potential.

14. The computer program product of claim 13, further comprising:
sending the subsequent poll to the identified specific set of users that includes at least one follow up question based on the result of the poll.

15. A computer system for the location-based dynamic polling application, the computer system comprising:
one or more computer processors, one or more computer-readable storage media, and program instructions stored on one or more of the computer-readable storage media for execution by at least one of the one or more processors capable of performing a method, the method comprising:
receiving, by a computer, a poll with at least one poll question and at least one potential answer for each at least one poll question from a creator;
receiving a specified polling location and additional polling criteria from the creator, wherein the specified polling location is used to target a specific set of users;
identifying the specific set of users within the specified polling location that match the additional polling criteria by tracking a plurality of user computing devices;
sending the poll to the specific set of users; and
generating a result of the poll by adding up each vote from each of the users of the specific set of users.

16. The computer system of claim 15, further comprising:
performing an action based on the generated result, wherein the action is selected from a group consisting of adding a via point to a travel route, transmitting user-provided information to a third party, displaying the results of the poll to the group, and generating a subsequent poll to transmit to the specific set of users.

17. The computer system of claim 15, further comprising:
receiving an indication from the creator that the poll is ready to be sent, wherein the indication is selected from a group consisting of a user interaction with a button and a user finger swipe in a preconfigured direction.

18. The computer system of claim 15, further comprising:
receiving a vote for a poll answer from each of the users who participate in the poll.

19. The computer system of claim 15, further comprising:
displaying the result of the poll.

20. The computer system of claim 15, further comprising:
receiving a subsequent poll with at least one poll question and at least one potential.
